(19) United States
(12) Patent Application Publication
(10) Pub. No.: US 2026/0034672 A1
(43) Pub. Date: Feb. 5, 2026

(54) COORDINATE POSITIONING MACHINE

(71) Applicant: RENISHAW PLC, Wotton-under-Edge, Gloucestershire (GB)

(72) Inventors: Julius Benjamin DUPREZ, Marne la Vallée (FR); Jean-Louis GRZESIAK, Marne la Vallée (FR)

(73) Assignee: RENISHAW PLC, Wotton-under-Edge, Gloucestershire (GB)

(21) Appl. No.: 18/996,128

(22) PCT Filed: Jul. 28, 2023
(86) PCT No.: PCT/EP2023/071017

§ 371 Date: Jan. 17, 2025

(30) Foreign Application Priority Data
Jul. 28, 2022 (FR) FR2207808

(51) Int. Cl. B25J 9/16; G01B 21/04

(52) U.S. Cl. CPC B25J 9/1692; B25J 9/1653; G01B 21/042; G05B 2219/39026

(57) ABSTRACT

A method of calibrating a coordinate positioning machine having a first member that is moveable relative to a second member, wherein the geometry of the machine is characterised by a set of model parameters. The machine is controlled to make point contact between multiple reference surfaces of a tool or artefact mounted on the first member and multiple reference surfaces of an artefact mounted on the second member. At least one of the model parameters is updated knowing or taking into account that the actual separations between the relevant surfaces are zero when making contact, even if the expected separations between the relevant surfaces as derived from the current model parameters are non-zero.

The present invention relates to a coordinate positioning machine. The present invention relates in particular, but not exclusively, to a system for calibrating or otherwise characterising at least some aspect of a coordinate positioning machine. The present invention is particularly applicable, for example, to a non-Cartesian type of coordinate positioning machine, such as a hexapod, measurement arm or articulated robot.

Articulated robots are commonly used in a wide variety of manufacturing applications such as assembly, welding, gluing, painting, picking and placing (e.g. for printed circuit boards), packaging and labelling, palletizing, and product inspection. They benefit from being versatile and rugged, with a large reach and a high degree of flexibility of movement, making them ideal for use in a production environment.

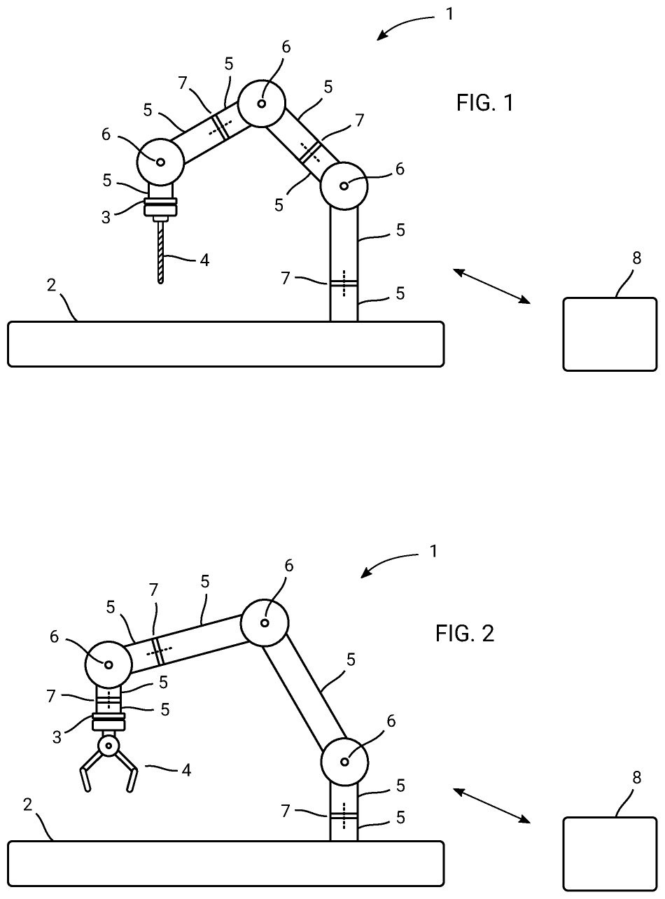

An articulated robot (or just “robot” for short) is illustrated schematically in FIG. 1 of the accompanying drawings, comprising an articulated robot arm 1 extending from a fixed base 2 to a moveable flange 3, with the flange 3 supporting a tool (or end effector) 4. The tool 4 in FIG. 1 is a drilling tool. Typically, the flange 3 is provided with a coupling which allows for the tool 4 to be conveniently interchangeable, so that a variety of tools or end effectors can be employed depending on the application concerned; examples include grippers, vacuum cups, cutting tools (including both mechanical and laser cutting tools), drilling tools, milling tools, deburring tools, welding tools and other specialized tools. The flange 3 can also be referred to more generally as the “head” of the robot arm 1, with the fixed base 2 being the “base” and with the robot arm 1 being controlled to move the head relative to the base by commands from a machine controller 8. The flange 3 is also sometimes referred to as the “hand” of the robot arm 1.

The arm 1 comprises a plurality of segments 5 connected by a mixture of transverse rotary axes 6 and inline (or longitudinal) rotary axes 7, forming a mechanical linkage from one end to the other. In the example illustrated in FIG. 1, there are three transverse rotary axes 6 and three inline rotary axes 7, making a total of six rotary axes, alternating between transverse rotary axes 6 and inline rotary axes 7. An additional inline rotary axis 7 (not shown in FIG. 1) could also be provided between the final transverse rotary axes 6 and the flange 3, to provide convenient rotation of the tool 4 around its longitudinal axis, making a total of seven rotary axes. In general, rotary axes of a robot need not be exactly orthogonal or exactly longitudinal but can be arranged at any desired angle.

Another common arrangement is shown in the arm 1 of FIG. 2, which includes the additional inline rotary axis 7 mentioned above, between the final transverse rotary axis 6 and the flange 3, and which also omits the second inline rotary axis 7 from FIG. 1 (in series order from the base end to the head end), thereby making a total of six rotary axes. The tool 4 in FIG. 2 is a gripper. The arm 1 of FIG. 2 is a schematic representation of the well-known IRB 140 six-axis industrial robot by ABB Robotics. The final three axes 6, 7 form a “wrist” of the robot arm 1, with the centre of the wrist being at the centre of the final transverse rotary axis 6. The centre of the wrist is invariant to rotation of the three rotary axes 6, 7 of the wrist, such that operation of the three rotary axes 6, 7 changes the orientation of whatever is attached to the wrist (in this case the gripper 4) without changing the position of the wrist centre, with the first three rotary axes 6, 7 of the robot arm 1 determining the position of the wrist centre. The wrist may be readily detachable from the remainder of the arm 1.

The articulated robot arms 1 of FIGS. 1 and 2 are examples of a non-Cartesian coordinate positioning machine because, in contrast to a Cartesian machine such as a traditional three-axis (X, Y, Z) coordinate measuring machine (see for example FIG. 1 of PCT/GB2020/052593), its axes are not arranged orthogonally according to a Cartesian coordinate system. The arms 1 of FIGS. 1 and 2 are also examples of a “serial kinematic” coordinate positioning machine, because their axes of movement are arranged in series. In this sense, such a machine is similar to a traditional three-axis Cartesian coordinate measuring machine, which is also an example of a “serial kinematic” coordinate measuring machine, and is to be contrasted with a “parallel kinematic” coordinate positioning machine such as a hexapod whose axes of movement are arranged instead in parallel.

Each joint or axis in a coordinate positioning machine contributes a positional error or uncertainty. In a serial kinematic machine such as that shown in FIGS. 1 and 2, because of the serial nature of the linkages, these errors are cumulative. Whilst this accumulation of positional errors does not occur in the same sense with a parallel kinematic machine, regardless of machine type it is important to calibrate the machine in order to map out these errors or uncertainties.

Calibration of any type of non-Cartesian machine is a significant challenge, and particularly so for an articulated arm such as that illustrated in FIGS. 1 and 2 having a plurality of rotary axes that are: (a) arranged in series; (b) are not fixed relative to one another; and (c) that can combine in complicated ways to position the tool in the working volume. Calibration of a Cartesian machine is typically more straightforward, because such a machine has three well-defined axes that are fixed relative to one another in an orthogonal arrangement, with each axis being largely independent of another. With an articulated robot, the position and orientation of each axis depends on the position and orientation of each other axis, so that the calibration will be different for each different machine pose.

Many calibration techniques have in common the goal of specifying a parametric model of the machine concerned, in which a set of model parameters (also referred to as machine parameters) is used to characterise the machine's geometry. Uncalibrated values are initially assigned to these parameters as a starting point for the machine geometry. During the calibration, the machine is moved into a variety of different poses (based on the current estimates of the machine parameters). For each pose, a calibrated measuring device is used to measure the actual pose, so that an indication of the error between the assumed machine pose and the actual machine pose can be determined.

The task of calibrating the machine then amounts to determining a set of values for the various machine parameters that minimises the errors, using known numerical optimisation or error minimisation techniques. An example of such a technique is the well-known Levenberg-Marquardt algorithm, which uses a least-squares approach to minimise errors knowing the derivatives of the errors according to each parameter optimised (“A Method for the Solution of Certain Non-Linear Problems in Least Squares”, Kenneth Levenberg, 1944, Quarterly of Applied Mathematics, 2:164-168; and “An Algorithm for Least-Squares Estimation of Nonlinear Parameters”, Donald Marquardt, 1963, SIAM Journal on Applied Mathematics, 11 (2): 431-441). Other techniques are also possible, including those based on a maximum likelihood approach.

For a robot arm as illustrated in FIGS. 1 and 2, these machine parameters might include various geometrical parameters such as the length of each of the segments 5 and the rotation angle offset of each of the rotary axes or joints 6, 7 (with the angle from the encoder plus the calibrated offset giving the actual angle), as well as various mechanical parameters such as joint compliance and friction. The machine parameters might also include the offset coordinates of the working point of the tool, such as the tip of the drilling tool 4 of FIG. 1, relative to the head or flange 3. In this respect, the offset of the working point (or tool centre point) is an important piece of information, and this will be discussed in more detail below.

When properly calibrated, with all of these machine parameters known, it is possible to predict with more certainty in what position the working point (or tool centre point) of the tool 4 will actually be when the various axes or joints 6, 7 are commanded by the controller 8 to move to different respective positions. In other words, the machine parameters resulting from such a calibration provide a more accurate characterisation of the machine geometry. These concepts, relating to calibration of coordinate positioning machines in general, and robot arms in particular, are explored in greater detail in WO 2019/162697 A1 and WO 2021/116685 A1.

However, challenges associated with calibrating a non-Cartesian machine such as described above remain, and it is desirable to find an improved method of and system for calibrating or otherwise characterising such a non-Cartesian coordinate positioning machine. Such a method and system can also find more general applicability to other types of coordinate positioning machine.

According to a first aspect of the present invention there is provided a method of calibrating (or otherwise characterising) a coordinate positioning machine (for example a robot) having a first member (for example a flange or spindle or moving platform) that is moveable relative to a second member (for example a fixed platform). The geometry of the machine is characterised by a set of model parameters. The method comprises: (a) controlling the machine to make (point) contact between multiple (different and/or distinct) reference surfaces of a tool or artefact mounted on the first member (this being denoted the first artefact/tool) and multiple (different and/or distinct) reference surfaces of an artefact mounted on the second member (this being denoted the second artefact); and (b) updating at least one of the model parameters knowing (or taking into account) that the actual separations (between contacting surfaces) are zero. In this respect, it is known in step (b) that the actual separations are zero because the contacting surfaces are known to be in contact with one another, such that the separation between them (or at least the closest separation between them) is zero (i.e. at the contact point). This is so even if the expected separations between the relevant surfaces, i.e. as expected (or derived) from the current model parameters, are non-zero (because the model parameters in practice will not typically provide a perfect characterisation of the machine geometry).

Step (a) may comprise (i) making (e.g. at least three) point contacts between an end surface of the first artefact/tool and a top surface of the second artefact, with the same orientation of the first artefact/tool for each contact. This may enable characterisation of an orientation of the top surface or a normal to the top surface, for example to update the Z vector of a tool setter frame.

Step (a) may comprise (ii) making (e.g. at least four) point contacts between an end surface of the first artefact/tool and a top surface of the second artefact, with a different orientation of the first artefact/tool for each contact. This may enable characterisation of a reference point associated with the end surface of the first artefact/tool, for example the centre of a spindle sphere, for example to update a spindle frame with the origin at the centre of the spindle sphere.

Step (a) may comprise (iii) making (e.g. at least three) point contacts between an end surface of the first artefact/tool and a side surface of the second artefact at different positions around the side surface of the second artefact. These positions may be in a reference plane through the second artefact, for example around a reference circle such as the equator of a tool setter sphere on the second artefact. An axis of the first artefact/tool in step (a)(iii) may be aligned with or parallel to an orientation (e.g. the normal to the top surface) determined in a previous step, for example step (a)(i), such as the Z vector of a tool setter frame. This may enable characterisation of a position of a reference point of the second artefact, for example the centre of a tool setter sphere, and/or a dimension of the first artefact/tool, for example the apparent radius of the spindle sphere, and/or a dimension of the second artefact, for example the apparent radius of the tool setter sphere. This may be used to update a tool setter frame origin with the XY position of a tool setter sphere centre and the Z position offset from a known (calibrated or machined within specification) radius of a spindle sphere.

Step (a) may comprises (iv) making (e.g. at least three) point contacts between a side surface of the first artefact/tool and a side surface of the second artefact. This may enable characterisation of an orientation of an axis of the first artefact/tool and/or a position of a reference point or axis of the first artefact/tool (at least relative to the first member). An axis of the first artefact/tool in step (a)(iv) may be aligned with or parallel to an orientation (e.g. the normal to the top surface) determined in a previous step, for example step (a)(i), such as the Z vector of a tool setter frame. This may be used to update a tool setter frame with the Z vector going from a shank section centre to a stylus sphere centre.

The method may comprise performing step (a)(iv) for at least two different positions along the length (or axis) of the first artefact/tool. This may be instead of performing step (a)(iii).

The first artefact/tool may have a defined and/or identifiable axis, for example a longitudinal axis. The first artefact/tool may be an elongate artefact/tool having a defined and/or identifiable axis, for example a longitudinal axis.

In the case where the first artefact/tool is an artefact rather than a tool, the first artefact may have revolute surfaces in line with the tool axis (e.g. a sphere on the axis, a cylinder parallel or coincident with the axis). The desired tool frame may be in line with the tool axis (e.g. TCP on the line and/or one vector of the frame parallel to the axis).

An end surface of the first artefact/tool may be spherical or at least revolute, at least where contact is made with the second artefact. The centre of the at least part spherical or revolute surface may lie substantially on the defined and/or identifiable axis of the first artefact/tool.

A side surface of the first artefact/tool may be cylindrical, at least where contact is made with the second artefact. The axis of the at least part cylindrical surface may be substantially parallel to the defined and/or identifiable axis of the first artefact/tool, for example substantially in line with the defined and/or identifiable axis of the first artefact/tool.

A side surface of the first artefact/tool may be axially symmetric in a single rotational axis (a single revolute axis), so that it could for example be cylindrical or conical, at least where contact is made with the second artefact.

A top surface of the second artefact may be planar, at least where contact is made with the first artefact/tool.

A side surface of the second artefact may be spherical, at least where contact is made with the first artefact/tool.

The second artefact may comprise a planar surface and a spherical surface (at least where contact is made with the first artefact/tool). The relative positional relationship between these two surfaces does not need to be known.

The first tool/artefact may comprise a cylindrical surface (at least where contact is made with the second artefact/tool) having an axis that is substantially parallel to (and optionally substantially in line with) the defined and/or identifiable axis of the first tool/artefact.

The first tool/artefact may comprise a spherical or revolute surface (at least where contact is made with the second artefact/tool) having a centre which lies substantially on the defined and/or identifiable of the first tool/artefact lies.

In the case where the first artefact/tool is an artefact rather than a tool, the method may further comprise mounting a tool on the first member in place of the first artefact (preferably using a common mounting system to provide a common alignment between the tool frame and the first artefact frame), and making at least one further contact between an end surface of the tool and a top surface of the second artefact to determine a length associated with the tool (or a value related to the tool length). It will be appreciated that this also applies if the first artefact/tool is a tool rather than an artefact, since it is quite possible to calibrate with a first cutting tool and then mount a second cutting tool and adjust the length. This step may be performed taking into account the updated model parameter(s) resulting from step (b), for example in terms of relative alignment between the tool and the second artefact.

The method may comprise updating a tool centre point associated with the tool based on the length. In this respect, the tool centre point may be considered to form part of the model parameters of the machine.

The method may comprise using an at least nominal geometric model representing the geometry of the first artefact/tool and/or the second artefact in step (a) and/or step (b).

The method may comprise using calibrated dimensional measurements of the second artefact (for example from an independent and/or calibrated coordinate measuring machine) in step (a) and/or step (b).

The reference surfaces of the second artefact may be metrological surfaces. In the case where the first artefact/tool is an artefact rather than a tool, the reference surfaces of the first artefact may be metrological surfaces. A metrological surface in this context may be considered to be one that is accurate in a metrology sense, for example planar or spherical to within a predetermined accuracy and/or acceptable for use as a reference surface in a metrology method.

The method may comprise sensing contact between the first artefact/tool and the second artefact using a sensor.

The sensor may be mounted on the second member.

The sensor may be a contact sensor having a deflectable stylus and a contacting member for contacting an object being sensed.

The second artefact may be used as the contacting member of the contact sensor.

The sensor may be a touch probe or a tool setter.

The second artefact may comprise a planar reference surface and a spherical reference surface (or at least part spherical reference surface). The (at least part) spherical reference surface may define a plurality of possible contact points in a circular (or at least part circular) arrangement. These contact points may be arranged in a plane that is parallel to the planar reference surface.

The second artefact may be in the form of a spherical segment (which is a segment of a sphere between two parallel planes intersecting the sphere) or a truncated sphere (which is a part of a sphere to one side of a plane intersecting the sphere).

Step (a) may comprise moving the first and second members relative to one another to bring (in turn) a plurality of different pairs of reference surfaces into point contact one another.

The coordinate positioning machine may be operable in step (a) to move the first member relative to the second member in six degrees of freedom.

At least one of the surfaces of the first artefact/tool and/or the second artefact may be a revolute surface. A revolute surface in this context may be considered as a surface that is rotationally or axially symmetric about a rotational or symmetry axis, or about an axis of curvature, for example as would be the case for the surface of a cylinder, sphere, or torus.

The revolute surface may have at least one revolute axis (or axis of rotational symmetry), for example as would be the case for a cylindrical surface.

The revolute surface may have at least two revolute axes (for example two revolute surfaces, for example as would be the case for a spherical surface.

Calibrating or otherwise characterising the machine may comprise one or more of calibrating, verifying, certifying and checking the performance of the machine.

The coordinate positioning machine may be a non-Cartesian and/or parallel kinematic machine.

The coordinate positioning machine may be a serial kinematic machine. The coordinate positioning machine may be an articulated arm (for example a robot arm). The coordinate positioning machine may have a plurality of rotary actuators arranged in series.

The coordinate positioning machine may be a hexapod. The coordinate positioning machine may have six linear actuators arranged in parallel.

The first member may be a moving member of the machine, such as an end effector or spindle or flange of a robot arm.

The second member may be a fixed member of the machine, such as a fixed platform or bed, or the base member of a serial kinematic machine such as a robot arm.

The second artefact may a calibration artefact. In the case where the first artefact/tool is an artefact rather than a tool, the first artefact may be a calibration artefact. An artefact may be considered to be a calibration artefact in this context when it has for example been measured by an independent and/or calibrated coordinate measuring machine and/or machined to within a predetermined and/or acceptable tolerance.

Step (b) may comprise determining a new set of model parameters which would fit the recorded contacts better than the existing set of model parameters, for example based on an objective function, thereby characterising the geometry of the machine better than the existing set of model parameters.

Step (b) may comprise determining an overall error value representing the expected separations, and updating at least one model parameter to reduce the overall error value, thereby making the expected separations based on the updated model parameters closer to zero overall or on balance, and thereby characterising the geometry of the machine better than the existing set of model parameters.

Step (b) may comprise iteratively updating the at least one model parameter, for example using an error minimisation or optimisation routine, until a predetermined test is met (such as based on the output of an objective function).

The model parameters may comprise a plurality of tool frame parameters (defining a tool frame). Step (b) may comprise updating at least three of the tool frame parameters. Step (b) may comprise updating three tool frame parameters defining the position of a point of interest of the tool frame such as a tool centre point. Step (b) may comprise updating five tool frame parameters defining the position and orientation of an axis of the tool frame. Step (b) may comprise updating six tool frame parameters defining the full coordinate system of the tool frame.

The model parameters may comprise a plurality of part frame parameters (defining a part frame). Step (b) may comprise updating at least three of the part frame parameters. Step (b) may comprise updating three part frame parameters defining the position of a point of interest of the part frame. Step (b) may comprise updating five part frame parameters defining the position and orientation of an axis of the part frame. Step (b) may comprise updating six part frame parameters defining the full coordinate system of the tool frame.

Step (b) may comprise determining a new value or new values for only a subset of the model parameters.

According to a second aspect of the present invention, there is provided a method of calibrating the axis of a spindle mounted to a coordinate positioning machine such as a robot arm, comprising performing a method according to the first aspect of the present invention, and wherein step (b) comprises determining at least the orientation of the axis (and preferably also the position of the axis).

According to a third aspect of the present invention, there is provided a method of checking and/or updating the tool or part frame of a tool or part mounted to (the moving or fixed member of) a coordinate positioning machine such as a robot arm, comprising performing a method according to the first aspect of the present invention, and wherein step (b) comprises checking and/or updating one or more parameters of the tool or part frame.

According to a fourth aspect of the present invention, there is provided a computer program which, when run by a computer or a machine controller, causes the computer or machine controller to perform one or more steps of a method according to the first aspect of the present invention.

According to a fifth aspect of the present invention, there is provided a computer-readable medium having stored therein computer program instructions for controlling a computer or a machine controller to perform one or more steps of a method according to the first aspect of the present invention.

According to a sixth aspect of the present invention, there is provided a computer or machine controller configured to perform one or more steps of a method according to the first aspect of the present invention.

According to a seventh aspect of the present invention, there is provided a system for calibrating or otherwise characterising a coordinate positioning machine comprising means for performing one or more steps of a method according to the first aspect of the present invention, or a computer program according to the fourth aspect of the present invention, or a computer-readable medium according to the fifth aspect of the present invention, or a computer or machine controller according to the sixth aspect of the present invention.

According to an eighth aspect of the present invention, there is provided a method of controlling a coordinate positioning machine which has been calibrated or otherwise characterised using a method according to the first aspect of the present invention.

According to a ninth aspect of the present invention, there is provided a coordinate positioning machine which has been calibrated or otherwise characterised using a method according to the first aspect of the present invention.

Reference will now be made, by way of example, to the accompanying drawings, in which:

FIG. 1, discussed hereinbefore, is a schematic illustration of a coordinate positioning arm in the form of an articulated robot, and carrying a drilling tool;

FIG. 2, also discussed hereinbefore, is a schematic illustration of an articulated robot having a different arrangement of rotary axes to that of FIG. 1, and carrying a gripping tool;

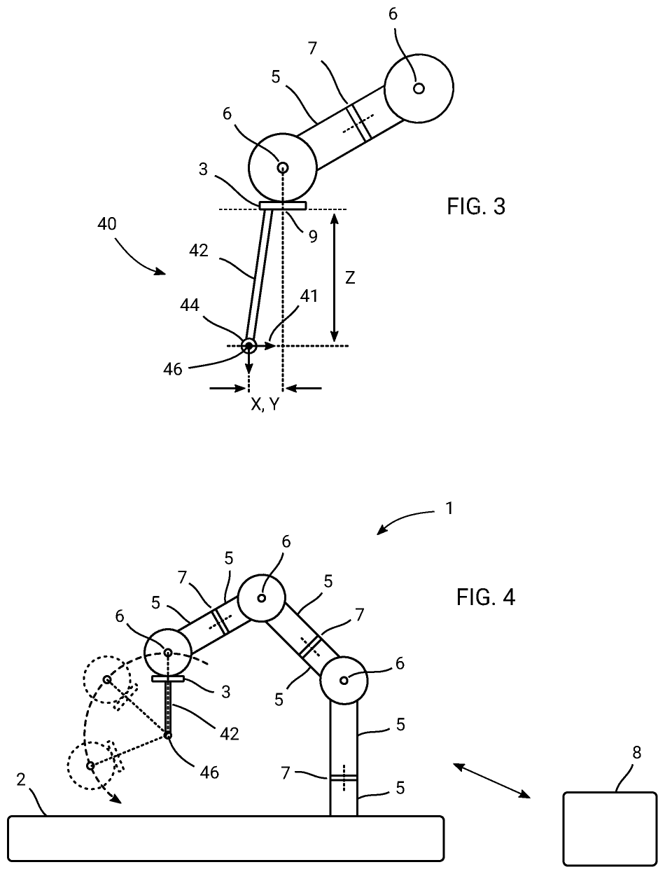

FIG. 3 is a schematic diagram for use in illustrating and describing in more detail the concept of a tool centre point and a tool frame;

FIG. 4 schematically illustrates a robot moving an attached tool in such a way that the tool centre point should remain in the same position; and

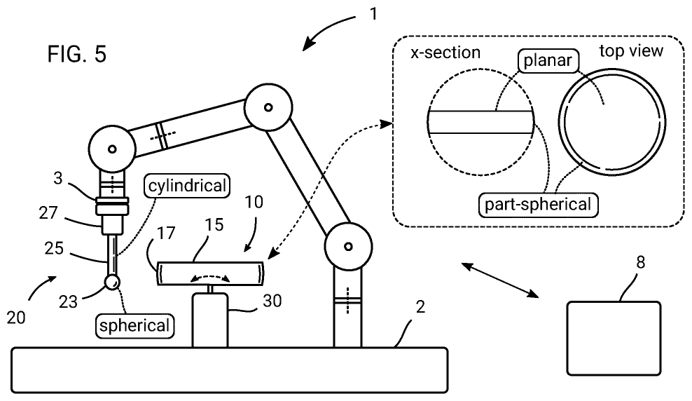

FIGS. 5, 6 and 7 are for use in explaining an embodiment of the present invention.

FIG. 3 shows a schematic representation of a tool 40 attached to a flange 3 of a robot arm of a type as described above with reference to FIGS. 1 and 2. The tool 40 has an elongate member 42 that is mounted at an angle to the flange 3 (the mounting angle may be deliberate or it could be inadvertent), with a tip 44 at a distal end of the elongate member 42. The centre 46 of the tip 44 is a particular point of interest because it would typically be the working point of the tool 40, or some other important reference point associated with the tool 40, and in a robot architecture this is commonly referred to as the tool centre point or TCP of the tool 40.

When programming a robot to move the tool 40 around the working volume, the location of the tool centre point 46 relative to the part of the robot to which the tool 40 is attached, i.e. the flange 3 in this case, is an important piece of information. Specifying the coordinates or offset (X, Y, Z) of the tool centre point 46 is a key step when setting up any robot for operational use. The tool centre point 46 is the point in relation to which all robot positioning is defined, and constitutes the origin of the tool frame (or tool coordinate system) 41 which is discussed in more detail below. The tool centre point 46 might correspond, for example, to the tip of an arc welding gun, the centre of a spot welding gun, the end of a grading tool, or the tip of a drilling tool such as that shown in FIG. 1.

The location of the tool centre point 46 will therefore depend on the application concerned.

It is to be noted that knowledge of the coordinates or offset of the tool centre point 46 does not imply knowledge of the orientation of the tool 40 relative to the flange 3, nor does it imply knowledge of the length of the tool 40, because the tool centre point 46 is defined relative to an arbitrary point 9 on the flange 3 that is known and defined internally, and this does not necessarily correspond to the point at which the elongate member or shaft 42 of the tool 40 is actually attached to the flange 3, as indeed is the case in the schematic example shown in FIG. 3. Therefore, determining the tool centre point 46 of the tool 40 is not the same as, and does not amount to, determining the orientation or direction or length or size of the tool 40.

In operation, it is the tool centre point 46 that will be jogged around or moved to the desired target position with the desired tool orientation. For example, with reference to the “wrist” concept for a robot arm of a type as described above with reference to FIG. 2, the first three rotary axes of the robot arm can be controlled to set the position of the wrist centre, the three rotary axes of the wrist can be used to change the orientation of the flange 3 relative to the first three axes, and the position of the key point of the working tool 40 relative to the flange 3 can be determined from the tool centre point (TCP) information. By knowing and controlling these aspects of the robot architecture, the position of the working point 46 of the tool 40 can be controlled in a relatively straightforward manner.

FIG. 4 schematically illustrates the robot arm 1 being instructed by the controller 8 to move the tool 40 so that the tool centre point 46 of the tool 40 remains in the same position, or at least should ideally remain in the same position. Such a test is typically performed to verify that the tool centre point 46 has been correctly identified and is sometimes known as a “tool orientation test”. The objective is to assess the robot's accuracy (and the accuracy of the coordinates X, Y, Z of the tool centre point 46 as shown in FIG. 3) by measuring its ability to rotate around the tool centre point 46 that is programmed into the controller 8, ideally without any actual movement of the tool centre point 46 being apparent when the test is being performed.

Rather than merely verify the position of the TCP as is done with the tool orientation test, several methods exist for determining the absolute position of the TCP. The most common method currently is the pin-to-pin method in which the operator visually aligns two pins with different orientations, one of which is fixed on the machine base and the other of which is moveable by the robot to reference the TCP, with the robot being controlled manually by an operator. This is a convenient method, but it is relatively inaccurate because it depends to a large extent on the skill and experience of the operator; it also requires the tool 40 to be removed and replaced by the pin. Other known methods can be very costly to implement, such as those that make use of non-contact measurement systems like a camera-based system, a laser scanner, and so on, or measuring the robot tool with a touch probe. Those methods are of a type to determine values for the TCP coordinates as part of a full calibration of the robot, including the TCP offset.

Also represented in FIG. 3 is a tool frame 41, and in this respect it should be noted that a distinction should be drawn between the tool centre point (TCP) 46 and the tool frame 41. Whilst the tool centre point 46 is a significant point of interest within the tool frame 41 (it is the origin of the tool frame 41 as mentioned above), it is defined in only three degrees of freedom (by a set of X, Y, Z coordinates) and therefore does not itself completely define the tool frame 41 (which requires six degrees of freedom for a full characterisation). It will be appreciated that a method embodying the present invention relates not only to characterisation of a specific point (such as the TCP 46) of the tool frame 41 (in three degrees of freedom), but also to characterisation of an axis of the tool frame 41 (in five degrees of freedom, i.e. position and orientation), and even to characterisation of a complete coordinate system of the tool frame 41 (in six degrees of freedom). For example, for the spot welding application mentioned above, only the position of the TCP is typically relevant (i.e. three degrees of freedom), whereas for the arc welding and machining applications the direction of the axis is also relevant (i.e. five degrees of freedom), while for assembly applications the full coordinate system (i.e. six degrees of freedom) would typically be required.

It will also be appreciated that, although the most standard setup for a robot is to have the tool moving and the part fixed, every robotic application can be set up the other way around (i.e. where the robot carries the part and moves it onto a fixed tool). As one example, where there are multiple operations to be performed on the same part, it might be preferable to have a single robot fitted with a gripper (for example as shown in FIG. 2) to hold the part and multiple tools fixed in front of the robot.

An embodiment of the present invention will now be described with reference to FIGS. 5 to 7.

For the reasons stated above with reference to FIG. 3, knowledge of the coordinates or offset of the tool centre point does not imply any knowledge of the length or size of the tool, or the orientation or direction of the tool relative to the flange of the robot arm. Likewise, where the tool is mounted to a rotatable spindle (having a defined spindle axis), for example on the head of a robot arm, knowledge of the tool centre point offset also does not imply any knowledge of the orientation or direction of the spindle axis.

An aim with this embodiment is to provide a method that can be used to calibrate the axis 29 of a spindle 27 mounted on a robot (position and orientation). This embodiment uses a touch tool setter 30, such as the Renishaw RTS or TS27 fitted with a multi-surface stylus artefact 10. The stylus artefact 10 presents as a disc stylus with a part-spherical surface 17 to the sides and a reference plane 15 on the top, as shown in FIGS. 5 to 7. At the end of a short procedure (typically involving a minimum of thirteen measurements) the five degrees of freedom of the spindle axis 29 are identified and the tool setter 30 is located to enable adjusting the production TCP according to the tool (e.g. drill) length.

In more detail, the method of this embodiment uses a tool setter 30 on the bed 2 of the machine 1 fitted with a stylus artefact 10 having two surfaces: the tool setter sphere 17 is the spherical surface of the disc stylus artefact 10, having a known radius, and the tool setter plane 15 is a plane on top of the disc stylus artefact 10. The disc stylus artefact 10, which is clearly shown in FIGS. 5 to 7, has a plurality of metrological or reference surfaces (i.e. the tool setter sphere 17 and the tool setter plane 15) that can be measured independently by a calibrated coordinate measuring machine (CMM).

The disc stylus artefact 10 in this embodiment is in the form of a spherical segment, i.e. a segment of a spherical object between two parallel planes, which is convenient to manufacture to a high level of accuracy. This is shown most clearly in the inset part of FIG. 5. In this embodiment the spherical segment is centred on the centre of the sphere. As will be appreciated from the steps set out below, the lower surface of the disc stylus artefact 10 does not form part of the method, and therefore could take any form and need not be formed to a metrological accuracy. The main features of the artefact 10 are a planar top surface 15 and an at least part spherical side surface 17 which defines a circle of available touch points that is parallel to the planar top surface 15. It will be appreciated that other geometric forms could be used for the artefact 10 instead of that shown in FIGS. 5 to 7, such as a generally triangular form (rather than circular form of the artefact 10), with convex curved side surfaces (similar to the convex side surfaces of the artefact 10).

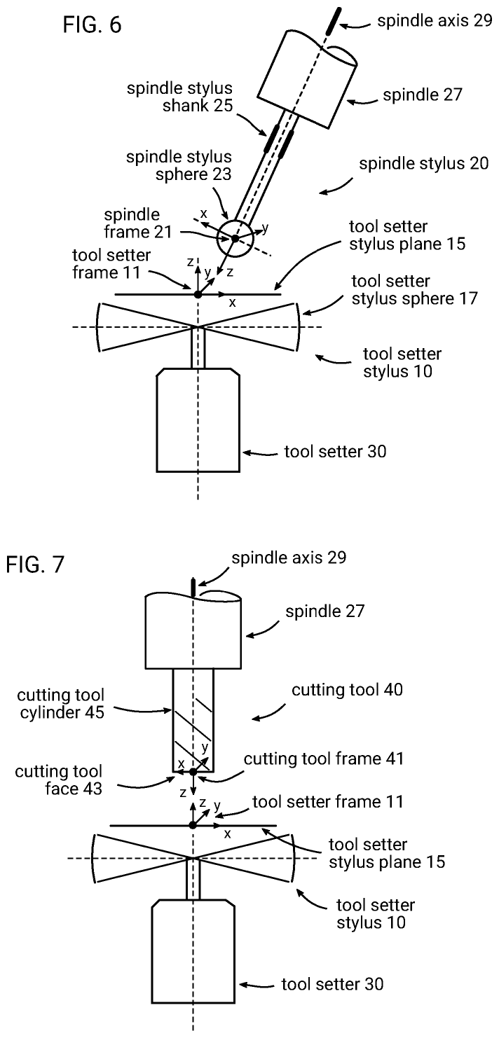

The method of this embodiment has two main stages: a setup stage and a length correction stage. For the setup stage, the multi-surface spindle stylus artefact 20 is mounted in the spindle 27, as shown in FIGS. 5 and 6. The spindle stylus artefact 20 in this example has two reference surfaces: a spindle sphere 23 which is centred on the spindle axis 29, and a spindle shank 25 which is a cylinder whose axis is coincident with the spindle axis 29. For the length correction stage, a cutting tool 40 (as one example) is mounted in the spindle 27, as shown in FIG. 7.

The steps performed in the setup stage (to locate the tool setter frame 11 and spindle frame 21) are as follows:

(a) Take three or more measurements with the spindle sphere 23 touching the tool setter plane 15 and without changing the orientation of the spindle 27. With this data, identify the direction of the normal to the tool setter plane 15. Update the tool setter frame 11 with the Z vector along the normal to the tool setter plane 15 and the origin at the altitude (Z position) of the measurements.

(b) Take four or more measurements with the spindle sphere 23 touching the tool setter plane 15 and change the orientation of the spindle 27 for each measurement. With this data, identify the centre of the spindle sphere 23 (using a well-known method which does not need to be described herein). Update the spindle frame 21 with the origin at the centre of the spindle sphere 23.

(c) Take three or more measurements with the spindle sphere 23 touching the tool setter sphere 17. The measurements should be taken nominally at the equator of the tool setter sphere 17 with the shank 25 nominally in line with the Z vector of the tool setter frame 11. Identify the XY coordinates of the centre of the tool setter sphere 17 and the apparent radius of the spindle sphere 23 (i.e. the fitted radius minus the known radius of the tool setter sphere 17). Update the origin of the tool setter frame 11 with the XY position of the centre of the tool setter sphere 17 and the Z position offset from the apparent radius of the spindle sphere 23.

(d) Take three or more measurements with the spindle shank 25 touching the tool setter sphere 17. The measurements should be taken nominally with the shank 25 nominally in line with the Z vector of the tool setter frame 11. Identify the XY coordinates of the local section of the tool setter shank 25. Update the tool setter frame 11 with the Z vector going from the shank section centre to the centre of the stylus sphere 23.

The following steps are performed in the length correction or compensation stage (of the cutting tool 40):

(a) Take one measurement with the cutting tool face 43 touching the tool setter plane 15. The measurement should be taken with the Z axis of the spindle frame 21 in line with the Z axis of the tool setter frame 11. Identify the length variation as the Z coordinate of the measurement. The cutting tool frame 41 is the same as the spindle frame 21 with a Z translation of the length variation.

Referring to the determination of length variation in the length correction stage above, this is in relation to the altitude (Z position) of the tool setter plane 15, which can be inferred from step (a) or step (b) from the setup stage described above. Alternatively, an additional step (e) can be added to the setup stage, in which a single measurement is taken with the stylus sphere 17 touching the tool setter plane 15 with the Z axis of the spindle frame in line with the Z axis of the tool setter frame. The tool setter frame is then set at the position of the measurement with an offset in Z of the radius of the stylus sphere 17.

Although the above-described method involves at least fourteen measurements (at least thirteen for the setup stage plus at least one more for the length compensation stage), it would be possible to reduce this to at least eight measurements by using some approximations that would be acceptable in practice. One further measurement would be added if the additional step (e) described above is also performed, i.e. there would be at least fifteen measurements or at least nine measurements with appropriate approximations in place.

Referring to the spindle stylus artefact 20, the diameter of the spindle sphere 23 is known, for example measured in advance by an independent coordinate measuring machine or manufactured to a known diameter to within a predetermined and/or acceptable tolerance. If the diameter of the cutting tool 40 is to be measured, then the diameter of the spindle shank 25 should also be known in a similar sense.

Possible variations to the method are as follows.

Referring to steps (c) and (d) above, where it is described to take three or more measurements with the spindle sphere 23 touching the tool setter sphere 17 in step (b) and then to take three or more measurements with the spindle shank 25 touching the tool setter sphere 17 in step (d), it would be possible to not to perform step (c) at all and instead perform step (d) twice at two different respective positions (or heights) along the spindle shank 25. For this variation, the axis of the spindle shank 25 need only be parallel with (and not necessarily coincident with) the spindle axis 29.

The setup stage can be performed directly with the production tool (e.g. cutting tool 40), without performing the length compensation stage. In this respect, if the production tool has a spherical end, the setup stage can be performed as described above directly with the production tool. Consideration should be given to the calibration of cutting tools that can be considered as a cylinder with a flat end or with a known radius between the cylinder and the face (i.e. like a torus).

The spindle 27 can be rotated during the measurements. In this respect, it is known generally to rotate the spindle during the calibration of cutting tools so that they appear like perfect cylinders or spheres. With the spindle stylus artefact 20 in the context of this embodiment, if the measurements are taken with the spindle 27 in rotation, it is not necessary to guarantee that the spindle sphere 23 and the spindle shank 25 and coincident with the spindle axis 29.

The setup stage can be re-run with fewer measurements. In this respect, some parameters of the setup may not have to be re-measured every time. The direction of the normal to the tool setter plane 15 and the apparent radius of the tool setter sphere 17 may be retrieved after a first setup. It would then be possible to remove five measurements from the procedure.

It will be appreciated that it is also possible to mount the spindle 27 on the fixed bed 2 of the machine 1, with the spindle 27 being calibrated using a probe 30 mounted on the moving member 3 of the robot 1 in an entirely equivalent way to what is described above for the reverse arrangement.

The method of this embodiment can be applied to the calibration of any robotic tool with a revolute surface provided that it can be replaced with a spindle stylus artefact 20 to perform the setup. If the robotic tool ends with a spherical surface or a pointy pin, the method can be applied directly and the length compensation is not required. Example applications may be: arc welding, laser cutting, waterjet, dispensing, spraying, etc.

It will be appreciated that, since the machine can be considered to comprise not only the robot arm but also any members attached to it (e.g. including the spindle 27 as the tool), the robot controller needs to know the spindle frame coordinates to move the robot into the correct positions, and hence the spindle frame coordinates can be considered to form part of the model parameters of the machine. The machine in this context can be considered to comprise a combination of the machine and any end effector or tool or member mounted to it.

It will be appreciated that, to create a point contact between two surfaces, the contact must be “curved to curved” or “curved to flat/planar”, with the curvature being convex (curving outward) rather than concave (curving inward). In particular, the contact must not be “flat/planar to flat/planar” because this would create contact across a surface (planar to planar contact is possible in some circumstances but it brings additional requirements in terms of setup and alignment). However, even where one or both surfaces are curved, care must still be taken to ensure that the two surfaces are mutually adapted (and also arranged relative to one another when contact is made) so as not to create multiple contact points, for example along a line such as would happen when two parallel cylinders make contact along their respective side surfaces or when a cylinder side surface contacts a plane. In the case of two cylindrical surfaces, these can be used to create a suitable point contact between them so long as they are arranged to be non-parallel when they make contact. In the case of a curved surface that contacts a planar surface, the curved surface must be doubly curved (like a sphere). These are just some examples, and the skilled person would understand what properties of the surfaces are required to achieve a point contact between them.

Creating multiple-point contact between surfaces (or even the possibility of this occurring) is considered to be undesirable because there will be uncertainty as to which of the multiple points is actually creating a constraint between the two contacting members. However, it will also be understood that a point of contact in the context of an embodiment of the present invention need not be (and in practice would not be) a mathematical point in the pure sense. Instead, in practice, a point would typically be a small area that approximates a point. The term “point contact” as used herein should therefore be interpreted accordingly as including within its scope a point-like contact such as that which would occur in practice.

Although planar to planar contact is not generally desirable, this type of contact is made in the length compensation stage described above, in which the cutting tool face 43 is made to contact the tool setter plane 15. However, this is why the measurement is made with the Z axis of the spindle frame 21 in line with the Z axis of the tool setter frame 11. Therefore, it will be appreciated that planar to planar contact is possible in some circumstances, but it brings additional requirements.

In the context of the present invention, a tool or artefact can be considered to have multiple reference surfaces if it has at least one reference surface that is geometrically different and/or distinct from at least one other reference surface of the tool or artefact, for example even if those two reference surfaces merge continuously into one another (without a distinct or noticeable joint between them). Two reference surfaces can be considered to be different and/or distinct from one another in the context of the present invention if they have (or are defined by) different and/or distinct respective geometric properties. For example, opposite sides of the same spherical surface would not be considered in this context to provide multiple (different and/or distinct) reference surfaces because they are defined by the same centre and radius/diameter. On the other hand, a cylinder and a sphere (or other type of convex curved surface) at the end of the cylinder would be considered to provide multiple (different and/or distinct) reference surfaces, because these two parts have different and/or distinct respective geometric properties. The same applies to a planar top surface and a curved side surface of an artefact, which have different and/or distinct respective geometric properties. Two cylinders having different respective diameters, even if arranged coaxially i.e. along the same axis, are considered to provide multiple (different and/or distinct) reference surfaces because the diameter is considered to be a geometric property of a cylinder. Accordingly, it will also be understood that the stylus of a standard contact probe would be considered in this context to have only one reference surface, or at least only one reference surface that is used for contacting a workpiece, i.e. the spherical surface of the stylus tip. Furthermore, the different sides of a triangular form of artefact described above (i.e. one having a generally triangular form with convex curved side surfaces) can be considered to provide a single reference surface (side surface), with each side having a common shape, a common axis and a common spacing and orientation relative to the common axis.

Calibration data collected during the performance of the method can be considered to reflect or represent the (recordable) state of the machine for each rotational position of the rotational movement (or based on some other sampling rate, if not for each rotational position). This type of information (forming part of the calibration data) is also be referred to herein as machine coordinates, which in this context is intended to mean a set of coordinates or values representing the state of the machine (e.g. encoder readings for each joint) for a particular pose. In this respect, the various physical motion axes of a machine, such as the linear axes defined by the extendible legs of a hexapod machine or the rotary axes of an articulated robot arm, can be considered herein to define a machine coordinate system, hence the term machine coordinates.

It will be appreciated that the present invention can be applied not only to calibration of a machine, but also to verification, certification, or performance checking of a machine. The terms calibration method, calibration artefact, calibration member, calibration data, calibration point and so on used herein should be interpreted accordingly in a broad sense, depending on the intended application, and not limited only to calibration as such. In other words, the concepts described herein apply not only to updating of the model parameters (calibration) but also checking or verification of the model parameters (verification or certification). Accordingly, these terms should be understood in the context of calibrating or otherwise characterising the machine. As one example, the term calibration artefact includes within its scope a gauge artefact. The terms target point, target artefact and target member could be used instead of calibration point, calibration artefact and calibration member respectively.

A machine controller for controlling the operation of the coordinate positioning machine may be a dedicated electronic control system and/or may comprise a computer operating under control of a computer program. For example, the machine controller may comprise a real-time controller to provide low-level instructions to the coordinate positioning machine, and a PC to operate the real-time controller. It will be appreciated that operation of the coordinate positioning machine can be controlled by a program operating on the machine, and in particular by a program operating on a coordinate positioning machine controller such as the controller 8. Such a program can be stored on a computer-readable medium, or could, for example, be embodied in a signal such as a downloadable data signal provided from an Internet website. The appended claims are to be interpreted as covering a program by itself, or as a record on a carrier, or as a signal, or in any other form.

1. A method of calibrating a coordinate positioning machine having a first member that is moveable relative to a second member, wherein the geometry of the machine is characterised by a set of model parameters, and wherein the method comprises: (a) controlling the machine to make point contact between multiple reference surfaces of a tool or artefact mounted on the first member and multiple reference surfaces of an artefact mounted on the second member; and (b) updating at least one of the model parameters knowing that the actual separations are zero.

2. A method as claimed in claim 1, wherein step (a) comprises (i) making a plurality of point contacts between an end surface of the first artefact/tool and a top surface of the second artefact, with the same orientation of the first artefact/tool for each contact.

3. A method as claimed in claim 1, wherein step (a) comprises (ii) making a plurality of point contacts between an end surface of the first artefact/tool and a top surface of the second artefact, with a different orientation of the first artefact/tool for each contact.

4. A method as claimed in claim 1, wherein step (a) comprises (iii) making a plurality of point contacts between an end surface of the first artefact/tool and a side surface of the second artefact at different positions around the side surface of the second artefact.

5. A method as claimed in claim 1, wherein step (a) comprises (iv) making a plurality of point contacts between a side surface of the first artefact/tool and a side surface of the second artefact.

6. A method as claimed in claim 5, comprising performing step (a)(iv) for at least two different positions along the length of the first artefact/tool.

7. A method as claimed in claim 1, wherein the first artefact/tool has a defined and/or identifiable axis.

8. A method as claimed in claim 1, wherein an end surface of the first artefact/tool is spherical or at least revolute, at least where contact is made with the second artefact.

9. A method as claimed in claim 8, wherein the centre of the at least part spherical or revolute surface lies substantially on the defined and/or identifiable axis of the first artefact/tool.

10. A method as claimed in claim 1, wherein a side surface of the first artefact/tool is cylindrical, at least where contact is made with the second artefact.

11. A method as claimed in claim 10, wherein the axis of the at least part cylindrical surface is substantially parallel to the defined and/or identifiable axis of the first artefact/tool, for example substantially in line with the axis.

12. A method as claimed in claim 1, wherein a top surface of the second artefact is planar, at least where contact is made with the first artefact/tool.

13. A method as claimed in claim 1, wherein a side surface of the second artefact is spherical, at least where contact is made with the first artefact/tool.

14. A method as claimed in claim 1, further comprising, in the case where the first artefact/tool is an artefact rather than a tool, mounting a tool on the first member in place of the first artefact, and making at least one further contact between an end surface of the tool and a top surface of the second artefact to determine a length associated with the tool, and optionally updating a tool centre point associated with the tool based on the length.

15.-17. (canceled)

18. A method as claimed in claim 1, wherein the reference surfaces of the second artefact are metrological surfaces and/or wherein, in the case where the first artefact/tool is an artefact rather than a tool, the reference surfaces of the first artefact are metrological surfaces.

19. (canceled)

20. A method as claimed in claim 1, comprising sensing contact between the first artefact/tool and the second artefact using a sensor, wherein the sensor is optionally mounted on the second member and is optionally a touch probe or a tool setter.

21. (canceled)

22. A method as claimed in claim 20, wherein the sensor is a contact sensor having a deflectable stylus and a contacting member for contacting an object being sensed, and wherein the second artefact is optionally used as the contacting member of the contact sensor.

23.-24. (canceled)

25. A method as claimed in claim 1, wherein the second artefact comprises a planar surface and an at least part spherical surface, wherein the at least part spherical surface optionally defines a plurality of possible contact points in an at least part circular arrangement in a plane that is substantially parallel to the planar surface of the second artifact.

26.-29. (canceled)

30. A method as claimed in claim 1, wherein at least one of the surfaces of the first artefact/tool and/or the second artefact is a revolute surface, for example having at least one revolute axis.

31.-43. (canceled)

44. A method as claimed in claim 1, wherein the model parameters comprise a plurality of tool frame parameters, and wherein step (b) comprises updating at least three of the tool frame parameters, for example three tool frame parameters defining the position of a tool centre point.

45. A method as claimed in claim 1, wherein the model parameters comprise a plurality of part frame parameters, and wherein step (b) comprises updating at least three of the part frame parameters, for example three part frame parameters defining the position of a point of interest of the part frame.

46. (canceled)

47. A method of calibrating the axis of a spindle mounted to a coordinate positioning machine such as a robot arm, comprising performing a method as claimed in claim 1, and wherein step (b) comprises determining at least the orientation of the axis.

48. A method of checking and/or updating the tool or part frame of a tool or part mounted to a coordinate positioning machine such as a robot arm, comprising performing a method as claimed in claim 1, and wherein step (b) comprises checking and/or updating one or more parameters of the tool or part frame.

49. (canceled)

50. A computer-readable medium having stored therein computer program instructions for controlling a computer or a machine controller to perform one or more steps of a method as claimed in claim 1.

51. A computer or machine controller configured to perform one or more steps of a method as claimed in claim 1.

52.-54. (canceled)
